(19) United States
(12) Patent Application Publication
(10) Pub. No.: US 2025/0221407 A1
(43) Pub. Date: Jul. 10, 2025

(54) Visible Antiseptic Solution (VAS)

(71) Applicant: John R. Dudley, West Richland, WA (US)

(72) Inventor: John R. Dudley, West Richland, WA (US)

(21) Appl. No.: 18/445,732

(22) Filed: Jan. 8, 2024

(51) Int. Cl. A01N 31/02; A01N 25/12

(52) U.S. Cl. CPC A01N 31/02; A01N 25/12

(57) ABSTRACT

Abstract: VISIBLE ANTISEPTIC SOLUTION (VAS), a robust and safe alcohol-based antiseptic solution, is highly visible on human skin enabling complete antiseptic coverage, unlike other antiseptics lacking visibility that inhibit complete antiseptic coverage, so that infections are prevented by killing, neutralizing or otherwise minimizing bacteria, fungi, viruses and other dangerous organisms from entering a patient.

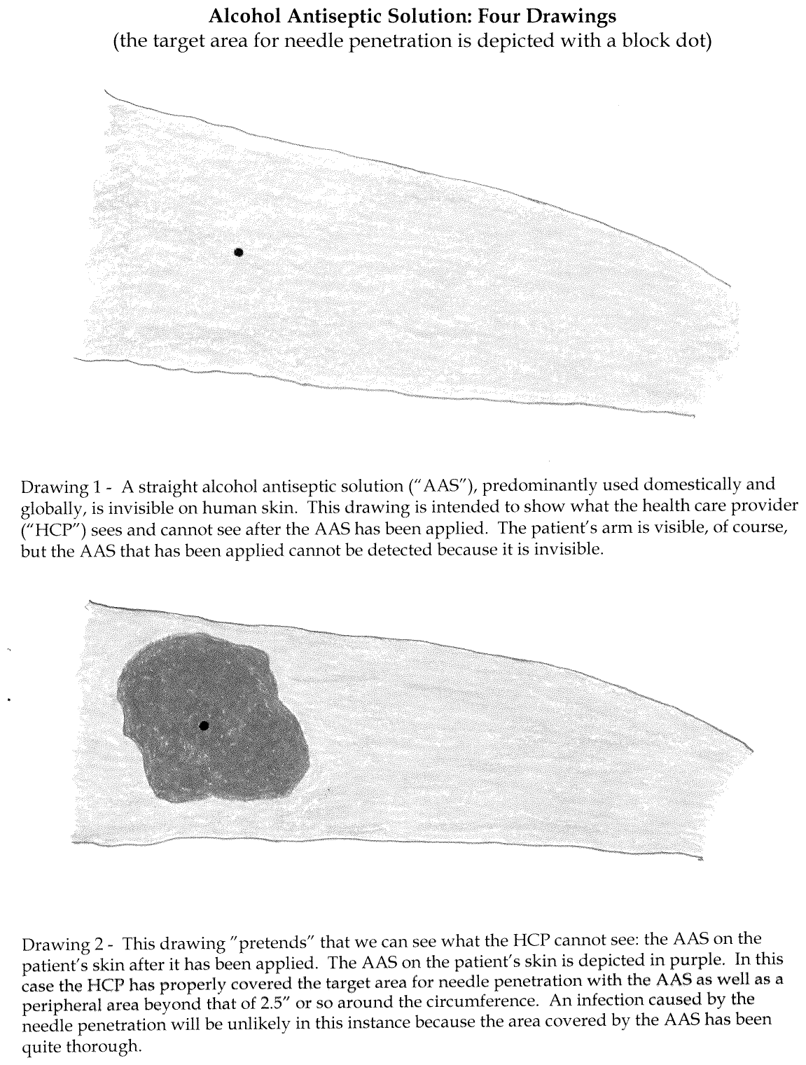

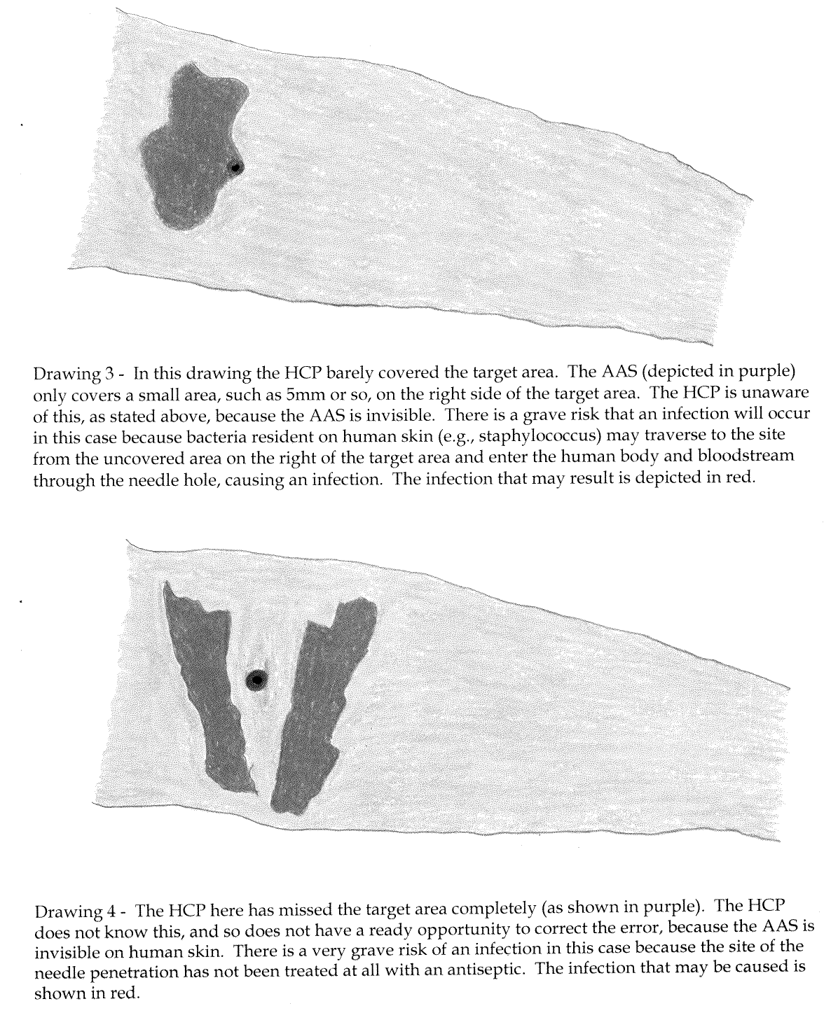

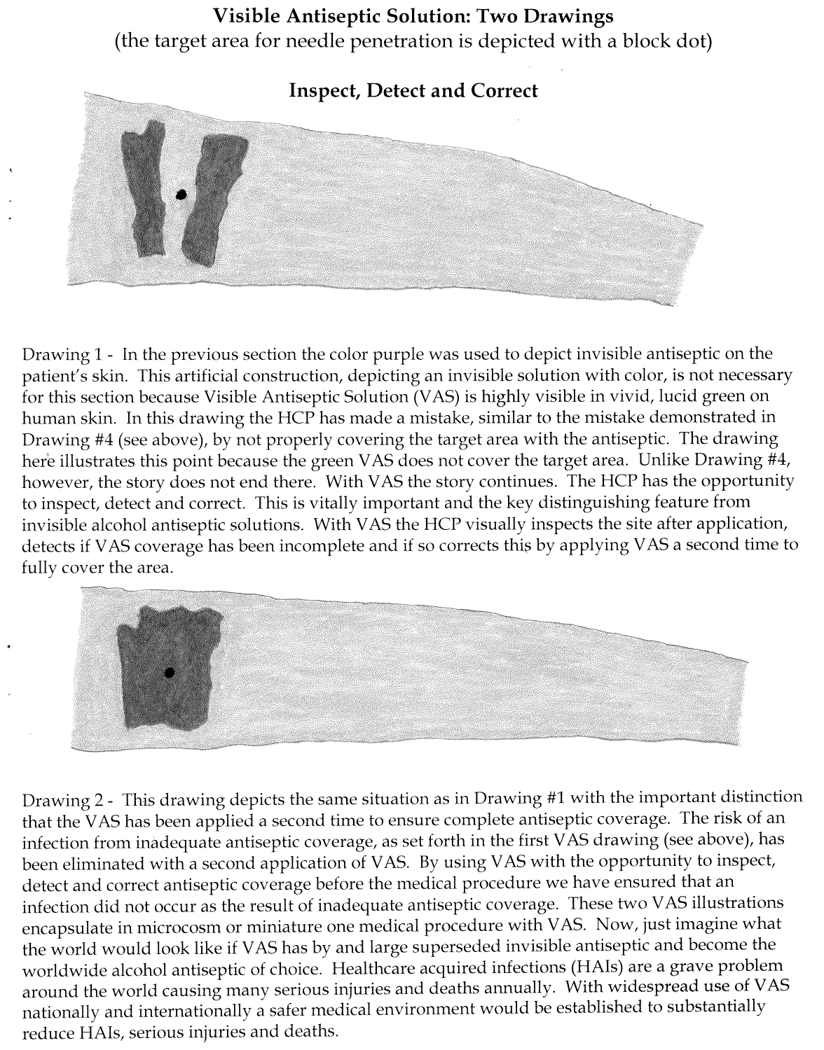

### (2) DESCRIPTION

Description: VISIBLE ANTISEPTIC SOLUTION (VAS), a robust and safe alcohol-based antiseptic solution, is highly visible on human skin enabling complete antiseptic coverage, unlike other antiseptics lacking visibility that inhibit complete antiseptic coverage, so that infections are prevented by killing, neutralizing or otherwise minimizing bacteria, fungi, viruses and other dangerous organisms from entering a patient.

### (3) TYPE OF APPLICATION

Type: Non-Provisional Application For A Patent.

### 2. CROSS REFERENCE TO RELATED APPLICATIONS

Not applicable.

### 3. STATEMENT RE FEDERALLY SPONSORED RESEARCH OR DEVELOPMENT

Not applicable.

### 4. REFERENCE TO SEQUENTIAL LISTING

Not applicable.

### 5. BACKGROUND OF THE INVENTION

### (1) Introduction to Healthcare Acquired Infections (HAI)

A large number of people in the United States are annually infected while under medical care. These infections are called HEALTHCARE-ACQUIRED INFECTIONS (HAI). They arise in a hospital, clinic or other setting, and were not present and were not incubating at the time of treatment in the hospital, clinic or other setting.

### (2) Prevalence of Healthcare Acquired Infections (HAIs)

In 2014 the Center for Disease Control (CDC) published a multistate point prevalence survey of HAIs occurring in the year 2011 involving 11,282 patients from 183 U.S. hospitals. According to this report, about 4% of hospitalized patients in 2011 suffered from a HAI. There were estimated to be 721,800 infections with 9.9% of these believed to be related to primary bloodstream infections.

This study was repeated by the CDC for the year 2015. 12,299 patients in 199 hospitals were surveyed. In this survey hospitalized patients contracted a HAI at the lower rate of 3.2%, representing a risk reduction of 16% in 2015 compared to 2011.

The encouraging HAI trend from 2011 to 2015 was reversed during the COVID-19 era from 2020 to 2023. The rate of HAIs during the COVID-19 era has risen to 11.3% according to the CDC.

Analysis by the CDC published in the Infection Control and Hospital Epidemiology Journal indicated that there were significant increases in HAIs in U.S. hospitals during 2021, the second year of the COVID-19 epidemic. Data from the National Healthcare Safety Network (NHSN) has revealed dramatically higher incidences of central line-associated bloodstream infections, catheter-associated urinary tract infections, ventilator-associated events and methicillin-resistant staphylococcus aureus bacteremia in 2021 compared to 2019. For instance, ventilator-associated events were 51% higher in the first quarter of 2021 compared to the first quarter of 2019.

### (3) Consequences of HAIs

Infections can cause very serious complications. In some cases a patient will need to go on antibiotic treatment for a year or more. In some cases a patient will suffer serious complications from HAIs, including loss of a limb. HAIs also cause a large number of fatalities. On May 6, 2022 the World Health Organization (WHO) released a report stating that “on average, 1 in every 10 patients will die from their HAI.” Therefore, HAIs cause serious health consequences and death. They are an enormous burden for the U.S. healthcare system and healthcare systems worldwide.

### (4) Key Qualities of the Invention

The invention, VISIBLE ANTISEPTIC SOLUTION (VAS), has several key qualities: (1) the use of a coloring agent, producing visibility on the skin, that has been approved by the Food and Drug Administration (FDA) to color drugs; (2) the use of alcohol as the active antimicrobial ingredient; and (3) the absence of any ingredient, active or inactive, that has been demonstrated to cause potential harm to human health when topically applied in a proper manner. There are several antiseptic solutions, including those described in the next section, with some measure of post-application visibility on a patient's skin. To the best my knowledge, none of these antiseptics have the VAS's key qualities described herein.

### (5) Other Antiseptic Solutions

HIBICLENS is an antiseptic solution that is red-pink in color. It is widely used in hospital operating rooms. Unlike the VAS, it has an active ingredient, a CHLORHEXIDINE GLUCONATE solution, that has been clinically proven to cause some adverse impact to human health. CHLORHEXIDINE GLUCONATE can cause breathing difficulties, severe and mild allergic reactions, skin rashes and other health problems.

BETADINE is an antiseptic solution that is golden brown in color. The active ingredients are PROVIDONE-IODINE, pareth 25-9, purified water and sodium hydroxide. Unlike the VAS, BETADINE contains an active ingredient, PROVIDONE-IODINE, that has been proven to cause health problems. IODINE can cause severe and mild issues involving livers, kidneys and the thyroid gland. It can also cause severe and mild allergic reactions.

MERCUROCHROME is an antiseptic solution that is dark red in color. The active ingredient is BENZALKONIUM CHLORIDE (including MERCURY or MERBROMIN). MERCUROCHROME has been customarily applied to a wound. Upon application MERCUROCHROME colors the skin red, making it difficult to detect inflammation or infection. This ineffectiveness, along with concerns about the toxicity of MERCURY, resulted in a decision by the FDA to ban MERCUROCHROME.

As a result of the FDA's ban MERCUROCHROME is not an antiseptic solution that is in widespread use. It has been included in this discussion, however, to illustrate the important difference between an antiseptic solution that is applied beforehand to prepare a patient for a procedure, on the one hand, and an antiseptic solution that is applied after-the-fact to address an infected or inflamed wound, on the other hand. In the former situation, visibility in the form of color, as highlighted by the VAS, is critically important so that the HCP can determine if the intended area for application of an antiseptic solution has been comprehensively covered. In the latter situation, visibility in the form of color, as dramatized by MERCUROCHROME, is disadvantageous because it masks or obscures the ability to detect an infection or inflammation.

In this way visibility serves as a marked advantage pre-procedure but is a clear disadvantage for post-procedure wound treatment. VAS is designed only for topical use pre-procedure to properly prepare a patient in order to kill, neutralize or otherwise minimize bacteria to prevent a HAI from occurring.

### (6) Colorless and Invisible Antiseptics

Antiseptic solutions in the United States are predominantly colorless and invisible. They are not visible on one's skin after application. This is a problem because the health care provider (HCP) applying the solution is not able to determine where it is on the patient's skin after application.

### (7) Visibility

The VAS solves the problem of lack of antiseptic visibility by integrating a coloring agent into the antiseptic solution to create visibility. By using the VAS the HCP can see where the antiseptic is on the skin and where it is not. With this visibility the HCP can make any necessary antiseptic adjustments before the procedure to kill, neutralize or otherwise minimize the introduction of bacteria into the patient. With the VAS the HCP has an advanced tool, in comparison to colorless and invisible antiseptics, to prevent bacterial absorption and infection.

### (8) Applying An Antiseptic vs. Washing A Car

The HCP applying an antiseptic solution shares some commonality of experience with a person washing his or her own car. In each case the primary objective is cleaning (with greater emphasis in the former case in killing, neutralizing or minimizing bacteria). In each case the person will customarily apply the selected solution in a manual manner by rubbing it on with a cloth, antiseptic wipe or other material.

Once the solution is applied, an antiseptic solution or a car washing solution, there is an important difference. Unless the HCP has applied an antiseptic solution that is visible, which is quite unlikely because antiseptic solutions are predominantly colorless and invisible, the HCP will be unable to determine where the antiseptic solution is located on the patient's skin and where it is not located. In contrast, the person washing a car will be able to determine whether or not he or she has missed one or more spots because the car washing solution is visible on the car.

This reality creates an ironic situation. The person washing a car who has missed a spot can readily rectify it by going back over the spot and cleaning it, but the HCP dealing with a life and death situation who has applied a colorless and invisible antiseptic solution cannot do so. The HCP who has missed a spot: (1) does not know whether or not he or she has missed a spot; and (2) consequently lacks visual information and feedback to apply antiseptic solution coverage to missed spots.

### (9) Questions

The difference between a HCP applying an antiseptic solution and a person washing a car raises several questions:
1. Why should a HCP applying an antiseptic solution be unable to see the solution after application while a person washing a car can see the car washing solution after application?
2. Why should the person washing a car be able to go over and cover up missed spots with the car washing solution while the HCP applying an antiseptic solution cannot cover up missed spots because the antiseptic solution cannot be seen on the skin?

### (10) Advancement

The VAS is an advancement in the medical field because it converts an otherwise invisible alcohol-based antiseptic solution into a highly visible antiseptic solution on the patient's skin. With a visible antiseptic solution the HCP in a hospital or clinical environment can redirect antiseptic solution application as warranted.

This redirection capability is only possible with a visible antiseptic. It provides the person applying the antiseptic with the ability to redirect the application as necessary, and ensure by visual inspection that the intended area of application is comprehensively covered. With complete antiseptic coverage there will be a significant reduction of bacterial absorption, and a resulting sharp reduction in fatal and non-fatal HAIs.

### (11) Demonstration of Meaningful Utility

The VAS has meaningful utility. This is demonstrated by explaining of the causes and types of HAIs, and how such problems are effectively addressed by the VAS's visibility.

### (12) Causes of HAIs

HAIs are caused by a wide variety of factors, including: (1) some HCPs lack sufficient education about infection control procedures; (2) some HCPs do not adhere to rigorous handwashing protocol; (3) HCPs are routinely under stress and time pressure, and consequently do not always take the requisite time to properly prepare a patient (PPP); (4) failure to use state-of-the-art antiseptic techniques; (5) failure to use appropriate antimicrobial strategy, prophylaxis and methodology; and (6) inadequate development, implementation and monitoring of antibiotic stewardship to avoid the rise of multi-drug resistant organisms.

While the VAS may not materially assist with Item #1 (education), Item #2 (handwashing) and Item #6 (antibiotic stewardship), it is believed that VAS will assist substantially with Item #3 (PPP), Item #4 (antiseptic techniques) and Item #5 (antimicrobial strategy) by giving HCPs an additional way to safeguard patient health from HAIs to prevent the introduction of bacteria during a surgery or other medical procedure.

### (13) Types of HAIs

The CDC has provided a summary of some major types of HAIs. These include: (1) central line-associated bloodstream infections; (2) catheter-associated urinary tract infections; (3) ventilator-associated pneumonia; and (4) surgical site infections. One type of HAI, catheter-associated urinary tract infections, is highlighted in the next section to explain how HAIs originate and how they can be prevented or substantially reduced by the subject invention.

### (14) Catheter-Associated Urinary Tract Infections

Urinary tract infections (UTIs) warrant special emphasis due to their prevalence. On Aug. 30, 2021 the National Library of Medicine reported that “globally, UTIs account for 20% to 40% of infections developed during hospitalization” (HAIs).

A urinary tract infection (UTI) is an infection in any part of the urinary system, including the urethra, bladder, ureters and kidneys. UTIs are often associated with the insertion of a urinary catheter into a patient. A urethral catheter is placed in the tube that carries urine out of the bladder to drain urine. Urethral catheters, as well as suprapubic catheters, are commonly used during and after surgery as well as in conjunction with certain other medical procedures.

A catheter can pick up dangerous bacteria when it is inserted into the patient by providing bacteria with a straightforward and unimpeded pathway into the bladder, causing infection. This can be prevented or minimized by: (1) establishing a maximal sterile barrier before catheter insertion; and (2) rigorously and thoroughly applying an antiseptic solution to an appropriate close surrounding area. See: later section, Close Surrounding Area.

The subject VAS is an advancement over existing medical science and practice because the antiseptic is visible on the patient's skin. This provides the HCP inserting a catheter with the opportunity to ensure that the antiseptic solution fully covers the targeted area.

Without the VAS the HCP is, in effect, flying blind. The antiseptic solution may be applied in accordance with established catheter insertion protocol, but because the antiseptic is colorless and invisible the HCP will probably be unable to kill or neutralize all threatening bacteria before it is introduced into the patient's bloodstream.

If the HCP does not fully cover the area with the antiseptic solution harmful bacteria can enter the patient's bloodstream even though a very small area has been left uncovered by the antiseptic solution. For example, even if an area as small as one (1) milliliter by one (1) milliliter is left uncovered by antiseptic this is enough for a threatening germ to enter the patient's bloodstream during a catheter insertion procedure.

By using the VAS, which is vivid green on the patient's skin, the HCP can be certain that the planned coverage area for antiseptic application is fully covered before the catheter is inserted. This will go a long way toward preventing catheter-associated urinary tract infections. Accordingly, it is a marked advancement in comparison to antiseptic solutions lacking visibility.

### (15) Common Denominators

While there are a number causes of HAIs not described herein, such as immune-compromised patients, it is possible to develop very useful information by studying the causes and types of HAIs. This yields a finding that a predominant number HAIs share a common denominator: namely, a colorless and invisible antiseptic solution was used.

There is widespread use of antiseptic applications in the United States that are both colorless and invisible. This is accompanied by inherent risk. Unless the antiseptic solution is fully applied to the targeted coverage area and is properly applied, including devoting sufficient time to enable the antiseptic to work, there is a grave danger that: (1) harmful bacteria will enter the patient's bloodstream; and (2) an infection will be caused.

### (16) Anatomy of an Infection

The VAS's utility can be illustrated with clarity by studying the anatomy of an infection. In this discussion we will: (1) dramatize how our selected protagonist, staphylococcus aureus bacteremia (“staph”), commonly causes an infection; and (2) explain how the comprehensive antiseptic coverage enabled by the VAS's highly visible solution will significantly reduce staph bacteria entering the patient's body, resulting in a pronounced decrease in staph infections.

Staph infections are widespread and can be deadly. The CDC reported that there were more than 119,000 staph infections in 2017 with almost 20,000 of these patients dying with bloodstream staph infections.

Staph is a germ found on the skin of healthy people. Most of the time staph bacteria does not cause any problems, or causes only minor skin infections. But staph infections can quickly become quite serious or even deadly if the staph bacteria penetrates deeply into the patient's body by invasion through the bloodstream. When such an invasion occurs internal organs such as the brain (meningitis), heart (endocarditis) or lungs (pneumonia) can be attacked and severely compromised. A bloodstream staph infection can also cause sepsis, an infection that affects one's entire body and can become life threatening when blood pressure drops to an extremely low level. The danger of patient infection through a staph infection is omnipresent because staph bacteria constantly lurk on one's skin. A person can go a long time without suffering an attack from staph bacteria even though such bacteria are always on one's skin. But an attack can happen in a moment's notice, for example, if the person's skin is: (1) opened up with an injury, punctured with a needle poke or otherwise exposed; and (2) the staph germ resident on the skin enters the place of injury or punctured hole and invades the person's bloodstream.

There is widespread misunderstanding about staph infections. This is partly because it only takes a very small staph germ to cause an infection with gravely serious or deadly ramifications. Misunderstanding is also present because the invading staph germ does not need to be directly located on the punctured hole (needle penetration spot) or on the immediate peripheral contour of the newly created hole, but can be further away.

Scientific data is inconclusive about how far away a staph germ can be from the punctured hole and still navigate to the hole and gain unimpeded entry into the bloodstream. Consequently, a conservative “close surrounding area” for application of the antiseptic solution must be adopted as a standard protocol. See: later section, Close Surrounding Area. A thorough, rigorous approach is required in every case to kill or neutralize all threatening germs. This will include not only such germs on the punctured hole and immediate periphery but all germs within the close surrounding area.

If antimicrobial preparation is not thorough with comprehensive antiseptic application coverage in the close surrounding area, along with such preparation on the punctured hole and in the immediate periphery, the staph germ will have an unimpeded pathway into the patient's bloodstream via the punctured hole. This can result in a staph infection. These infections can be crippling in severity. They are also fatal in about one (1) out of six (6) cases. See: the CDC's data about staph infections in 2017 set forth earlier in this section.

The medical community is in uniform agreement that a sound antiseptic strategy, prophylaxis and methodology is warranted to: (1) properly prepare a patient before a surgery or other medical procedure; and (2) safeguard a patient from the omnipresent danger of staph infections as well as other HAIs.

mBio is a bimonthly peer-reviewed medical journal published by the American Society for Microbiology in association with the American Academy of Microbiology. On May 29, 2018 mBio addressed the subject of antiseptic application and staph infections, stating: “increased usage of antiseptics is associated with reduced susceptibility in clinical isolates of staphylococcus aureus.” This is accomplished, according to mBio, by decolonizing such bacteria through antiseptic application before the bacteria can work virulently in a “carriage” or “transport” manner to reach the patient's bloodstream by entering the punctured hole, causing an infection. mBio is a representative voice in the medical community on this subject by describing the manner in which an effective antiseptic solution can be used to prevent staph bacteria from carriage, transport and other migration into the patient's bloodstream.

The HCP applying VAS's highly visible solution will be certain, with naked eye observation, to achieve the crucial objective described by mBio. This will be accomplished by verifying that the following areas have been thoroughly covered with antiseptic coverage on the patient's skin: (1) the targeted puncture spot; (2) the immediate periphery of the punctured spot; and (3) the close surrounding area. See: later section, Close Surrounding Area.

The HCP using a colorless and invisible antiseptic will not know if the staph germ has been killed, neutralized or otherwise minimized before a surgery or other procedure. This is because the antiseptic applied on the puncture spot, on the immediate periphery of the puncture spot and on the close surrounding area cannot be seen. Accordingly, the HCP will be unable to achieve the crucial objective described by mBio.

Importantly, the HCP using the VAS will not be laboring under this limitation because the antiseptic solution is a vivid green color on the patient's skin. Thus, the VAS is an advancement over existing colorless and invisible antiseptics and so will accomplish the vital, life-saving objective described by mBio to prevent staph infections by thorough application of a robust antiseptic.

### (17) Green Means “Go”

The VAS described herein is designed to be a substantial help in preventing infections. This is because the VAS is visible in a vivid green color immediately upon application. With the VAS the HCP will be able to determine upon inspection if the planned area has been comprehensively covered with the antiseptic. If so, green means “go.”

If the area has not been completely covered, it means “stop.” This gives the HCP an opportunity to take rectifying action to prevent the introduction of the bacteria before proceeding with the surgery or medical procedure. The HCP does this by comprehensively covering the targeted area with the green antibiotic solution. In this way the high utility of VAS is demonstrated through the manner in which it will provide the HCP with an opportunity to prevent the introduction of bacteria and a resulting HAI.

### (18) Anesthetic and Antiseptic

The HCP preparing a patient for a surgery or other medical procedure will ordinarily take two steps: (1) administer a local anesthetic, such as LIDO SPRAY (active ingredient LIDOCAINE HCI 5%) or AMERICAINE (active ingredient BENZOCAINE 20%) to numb the targeted area; and (2) administer an antiseptic to neutralize bacteria. The two treatments are not only quite different in purpose, but are also quite different in terms of information, or lack thereof, that the HCP receives in conjunction with administering each treatment.

With a local anesthetic the HCP receives valuable and immediate information with needle penetration that is either positive or negative. The information is positive if the patient endures the needle penetration without pain or discomfort. The information is negative if the patient suffers pain or discomfort.

This is not the situation that occurs when the HCP administers an antiseptic that is colorless and invisible. The HCP does not receive any post-application information because the area covered by the antiseptic is not visible.

The absence of post-application information provided by the customary antiseptic, colorless and invisible in nature, exemplifies the medical advancement of the VAS. Unlike a colorless and invisible antiseptic, the VAS provides immediate post-application information and visual feedback to the HCP. The HCP will be able to verify complete antiseptic coverage by visual inspection, and can redirect the antiseptic application as necessary to cover up any uncovered areas.

### (19) Close Surrounding Area

In preparing for needle penetration it is natural and expected that the HCP will cover the targeted spot and immediate periphery with an antiseptic. There is inherent risk if the person does not do more than this because: (1) the HCP may not know that certain bacteria, including previously referenced staph germs, may have carriage, transport or migration capability to travel to the penetration hole from an area beyond the targeted spot and immediate periphery; and (2) even if the HCP has such awareness, he or she may not know how much of an area beyond the targeted spot and immediate periphery to cover with antiseptic.

It is recommended that the close surrounding area should be a circular area overlaid on top of the punctured hole with a diameter of not less than eighteen (18) centimeters. With such a coverage area it is expected that the patient would be well protected from carriage, transport or migration of dangerous bacteria because such germs would need to travel more than nine (9) centimeters, half the distance of the circle's diameter, to reach the punctured hole.

The HCP with a colorless and invisible antiseptic solution is ill-equipped to completely cover the described close surrounding area with an antiseptic solution. This is because the solution cannot be visually detected post-application The subject VAS is an advancement in medical science because the HCP applying the solution can make certain through its visibility on the patient's skin that the solution has completely covered the close surrounding area.

(20) FDA Approval

Reliance has been placed on the resources, data and approvals of the Food and Drug Administration (FDA) to determine a safe and effective coloring agent. FD&C GREEN POWDER, also known as FD&C GREEN or FD&C GREEN POWDER NO. 3, has been used for the VAS.

21 Code of Federal Regulations (CFR) 74.1203 (b) provides that the color additive FD&C GREEN POWDER (FD&C GREEN or FD&C GREEN POWDER NO. 3) may be safely used for coloring drugs generally in amounts consistent with current good manufacturing practice. Good manufacturing practice has been adhered to because the coloring agent comprises only about 5% of the VAS.

According to 21 CFR 73B certain color additives, including FD&C GREEN POWDER, are exempt from batch certification. 21 CFR 73.1326 (C) additionally provides that chromium hydroxide green may be safely used in amounts consistent with good manufacturing practice to color externally applied drugs. See also: 21 CFR 73.1327 (C) for chromium oxide green.

The coloring agent used herein, FD&C GREEN POWDER, conforms to the requirements of 21 CFR 74.203 (a) (b). In compliance with 21 CFR 74.1203 (a) (2) the color additive mixture contains only those diluents that: (1) are suitable; and (2) are listed in Part 73 of the identified chapter of the CFR as being safe for use as a coloring additive mixture for coloring drugs.

Ethyl alcohol and isopropyl alcohol have been approved by the FDA for safe and effective skin antiseptic application, although n-propanol (a primary alcohol) has not yet been approved by the FDA for this purpose.

There is an additional level of safeguard for the VAS coloring agent. VAS is intended only for external use with proper topical application. It is not to be consumed, swallowed, inhaled or otherwise introduced improperly into the patient's body.

### 6. BRIEF DESCRIPTION

The VAS blends an agent creating visibility with an alcohol-based antiseptic solution. By using this antiseptic solution the HCP can: (1) visually detect the antiseptic solution on the skin of the patient; and (2) make real-time corrections in the application to prevent infections by killing, neutralizing or otherwise minimizing bacteria, fungi, viruses and other dangerous organisms from entering a patient.

### 7. DETAILED DESCRIPTION

Laboratory work and experiments have resulted in this VAS formulation: (1) 71.2% alcohol; (2) 23.6% water; and (3) 5.2% FD&C Green Powder. This yields a robust and safe antiseptic solution that is vivid green in color on human skin.

I claim:

1. An antiseptic solution, comprising:
a coloring agent for clear visibility of the antiseptic on human skin after application;
water; and
alcohol, antimicrobial agent, working with the antiseptic's clear visibility to prevent infections by stopping bacteria from entering a person.

2. An antiseptic solution, consisting of:
a coloring agent for clear visibility of the antiseptic on human skin after application;
water; and
alcohol, antimicrobial agent, working with the antiseptic's visibility to prevent infections by stopping bacteria from entering a person.

3. An antiseptic solution, consisting of:
2% ethyl alcohol;
6% water; and
2% FD&C Green Powder.
